(19) United States
(12) Patent Application Publication
(10) Pub. No.: US 2022/0129436 A1
(43) Pub. Date: Apr. 28, 2022

(54) SYMBOLIC VALIDATION OF NEUROMORPHIC HARDWARE

(71) Applicant: INTERNATIONAL BUSINESS MACHINES CORPORATION, Armonk, NY (US)

(72) Inventors: Alexander Andreopoulos, San Jose, CA (US); Dharmendra S. Modha, San Jose, CA (US); Andrew Stephen Cassidy, Austin, TX (US); Brian Seisho Taba, San Jose, CA (US); Carmelo Di Nolfo, San Jose, CA (US); Hartmut Penner, San Jose, CA (US); John Vernon Arthur, San Jose, CA (US); Jun Sawada, Austin, TX (US); Myron D. Flickner, San Jose, CA (US); Pallab Datta, San Jose, CA (US); Rathinakumar Appuswamy, San Jose, CA (US)

(21) Appl. No.: 17/077,759

(22) Filed: Oct. 22, 2020

(51) Int. Cl. G06F 16/23; G06N 3/04

(52) U.S. Cl. CPC G06F 16/2365; G06N 3/04

(57) ABSTRACT

Systems are provided that can produce symbolic and numeric representations of the neural network outputs, such that these outputs can be used to validate correctness of the implementation of the neural network. In various embodiments, a description of an artificial neural network containing no data-dependent branching is read. Based on the description of the artificial neural network, a symbolic representation is constructed of an output of the artificial neural network, the symbolic representation comprising at least one variable. The symbolic representation is compared to a ground truth symbolic representation, thereby validating the neural network system.

### STATEMENT REGARDING FEDERALLY SPONSORED RESEARCH OR DEVELOPMENT

This invention was made with government support under FA8750-18-C-0015 awarded by U.S. Air Force, Office of Scientific Research. The government has certain rights to this invention.

### BACKGROUND

Embodiments of the present disclosure relate to neural network processing, and more specifically, to a system that can produce symbolic and numeric representations of the neural network outputs, such that these outputs can be used to validate correctness of the implementation of the neural network.

### BRIEF SUMMARY

According to embodiments of the present disclosure, methods of and computer program products for validating a neural network system are provided. In various embodiments, a description of an artificial neural network containing no data-dependent branching is read. Based on the description of the artificial neural network, a symbolic representation is constructed of an output of the artificial neural network, the symbolic representation comprising at least one variable. The symbolic representation is compared to a ground truth symbolic representation, thereby validating the neural network system.

### BRIEF DESCRIPTION OF THE SEVERAL VIEWS OF THE DRAWINGS

FIG. 1 illustrates a neural core according to embodiments of the present disclosure.

FIG. 2 illustrates an exemplary Inference Processing Unit (IPU) according to embodiments of the present disclosure.

FIG. 3 illustrates a multi-core Inference Processing Unit (IPU) according to embodiments of the present disclosure.

FIG. 4 illustrates a neural core and associated networks according to embodiments of the present disclosure.

FIG. 5 is an exemplary schematic view of a symbolic validation according to embodiments of the present disclosure.

FIG. 6 is an exemplary schematic view of a symbolic validation, with recurrent nets, according to embodiments of the present disclosure.

FIG. 7 is an exemplary schematic view of a symbolic validation, with directed acyclic graph (DAG), according to embodiments of the present disclosure.

FIG. 8 illustrates a method for computing neural activations according to embodiments of the present disclosure.

FIG. 9 depicts a computing node according to an embodiment of the present disclosure.

### DETAILED DESCRIPTION

An artificial neuron is a mathematical function whose output is a nonlinear function of a linear combination of its inputs. Two neurons are connected if the output of one is an input to the other. A weight is a scalar value encoding the strength of the connection between the output of one neuron and the input of another neuron.

A neuron computes its output, called an activation, by applying a nonlinear activation function to a weighted sum of its inputs. A weighted sum is an intermediate result computed by multiplying each input with the corresponding weight and accumulating the products. A partial sum is a weighted sum of a subset of inputs. A weighted sum of all inputs may be computed in stages by accumulating one or more partial sums.

A neural network is a collection of one or more neurons. A neural network is often divided into groups of neurons called layers. A layer is a collection of one or more neurons that all receive input from the same layers and all send output to the same layers, and typically perform a similar function. An input layer is a layer that receives input from a source outside the neural network. An output layer is a layer that sends output to a target outside the neural network. All other layers are intermediate processing layers. A multilayer neural network is a neural network with more than one layer. A deep neural network is a multilayer neural network with many layers.

A tensor is a multidimensional array of numerical values. A tensor block is a contiguous subarray of the elements in a tensor.

Each neural network layer is associated with a parameter tensor V, weight tensor W, input data tensor X, output data tensor Y, and intermediate data tensor Z. The parameter tensor contains all of the parameters that control neuron activation functions σ in the layer. The weight tensor contains all of the weights that connect inputs to the layer. The input data tensor contains all of the data that the layer consumes as input. The output data tensor contains all of the data that the layer computes as output. The intermediate data tensor contains any data that the layer produces as intermediate computations, such as partial sums.

The data tensors (input, output, and intermediate) for a layer may be 3-dimensional, where the first two dimensions may be interpreted as encoding spatial location and the third dimension as encoding different features. For example, when a data tensor represents a color image, the first two dimensions encode vertical and horizontal coordinates within the image, and the third dimension encodes the color at each location. Every element of the input data tensor X can be connected to every neuron by a separate weight, so the weight tensor W generally has 6 dimensions, concatenating the 3 dimensions of the input data tensor (input row a, input column b, input feature c) with the 3 dimensions of the output data tensor (output row i, output column j, output feature k). The intermediate data tensor Z has the same shape as the output data tensor Y. The parameter tensor V concatenates the 3 output data tensor dimensions with an additional dimension o that indexes the parameters of the activation function σ. In some embodiments, activation function σ requires no additional parameters, in which case the additional dimension is unnecessary. However, in some embodiments, activation function σ requires at least one additional parameter, which appears in dimension o.

An element of a layer's output data tensor Y can be computed as in Equation 1 where the neuron activation function σ is configured by the vector of activation function parameters V [i, j, k, :], and the weighted sum Z[i, j, k] can be computed as in Equation 2.

$$\begin{matrix}Y [ i , j , k ] = σ ( V [ i , j , k , \text{:} ] ; Z [ i , j , k ] ) & Equation 1 \\ Z [ i , j , k ] = {\sum }_{a = 1}^{A} {\sum }_{b = 1}^{B} {\sum }_{c = 1}^{C} W [ i , j , k , a , b , c ] \cdot X [ a , b , c ] & Equation 2\end{matrix}$$

For simplicity of notation, the weighted sum in Equation 2 may be referred to as the output, which is equivalent to using a linear activation function Y[i, j, k]=σ(Z[i, j, k])=Z[i, j, k], with the understanding that the same statements apply without loss of generality when a different activation function is used.

In various embodiments, computation of the output data tensor as described above is decomposed into smaller problems. Each problem may then be solved on one or more neural core, or on one or more core of a conventional multicore system in parallel.

It will be apparent from the above that neural networks are parallel structures. Neurons in a given layer receive inputs, X with elements xᵢ from one or more layers or other inputs. Each neuron computes its state, y E Y based on the inputs and weights W with elements wᵢ. In various embodiments, the weighed sum of inputs is adjusted by a bias b, and then the result is passed to a nonlinearity F(⋅). For example, a single neuron activation may be expressed as y=F(b+Σxᵢwᵢ).

Because all neurons in a given layer receive inputs from the same layers and compute their outputs independently, neuron activations can be computed in parallel. Because of this aspect of the overall neural network, performing computation in parallel distributed cores accelerates overall computation. Further, within each core vector operations can be computed in parallel. Even with recurrent inputs, for example when a layer projects back to itself, all neurons are still updated simultaneously. Effectively, the recurrent connections are delayed to align with a subsequent input to the layer.

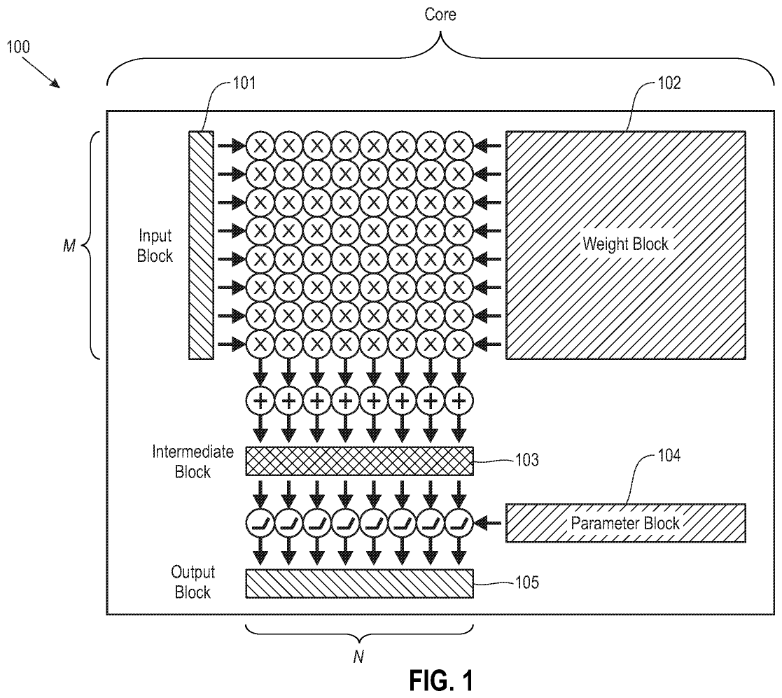

With reference now to FIG. 1, a neural core according to embodiments of the present disclosure is depicted. A neural core 100 is a tileable computational unit that computes one block of an output tensor. A neural core 100 has M inputs and N outputs. In various embodiments, M=N. To compute an output tensor block, a neural core multiplies an M×1 input tensor block 101 with an M×N weight tensor block 102 and accumulates the products into weighted sums that are stored in a 1×N intermediate tensor block 103. A 0×N parameter tensor block contains the 0 parameters that specify each of the N neuron activation functions that are applied to the intermediate tensor block 103 to produce a 1×N output tensor block 105.

Multiple neural cores may be tiled in a neural core array. In some embodiments, the array is 2-dimensional.

A neural network model is a set of constants that collectively specify the entire computation performed by a neural network, including the graph of connections between neurons as well as the weights and activation function parameters for every neuron. Training is the process of modifying the neural network model to perform a desired function. Inference is the process of applying a neural network to an input to produce an output, without modifying the neural network model.

An inference processing unit is a category of processors that perform neural network inference. A neural inference chip is a specific physical instance of an inference processing unit.

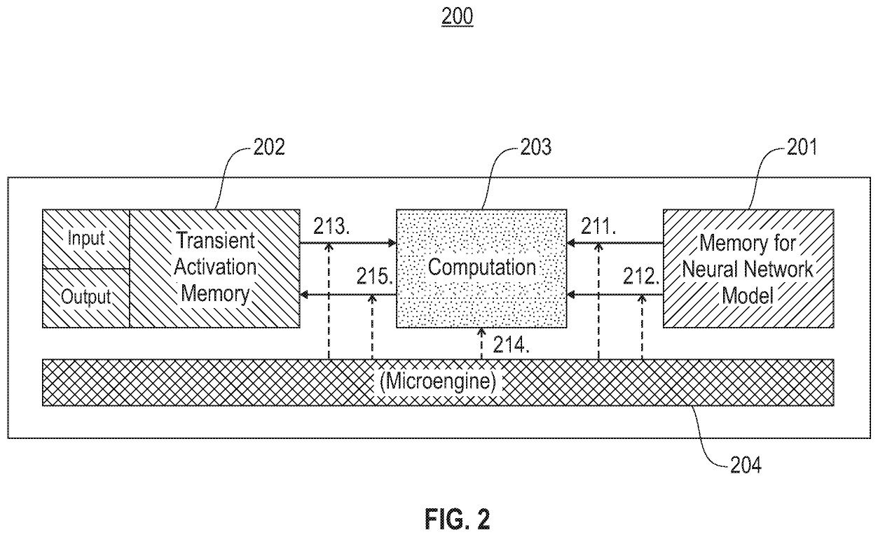

Referring to FIG. 2, an exemplary Inference Processing Unit (IPU) is illustrated according to embodiments of the present disclosure. IPU 200 includes a memory 201 for the neural network model. As described above, the neural network model may include the synapse weights for a neural network to be computed. IPU 200 includes an activation memory 202, which may be transient. Activation memory 202 may be divided into input and output regions, and stores neuron activations for processing. IPU 200 includes a neural computation unit 203, which is loaded with a neural network model from model memory 201. Input activations are provided from activation memory 202 in advance of each computation step. Outputs from neural computation unit 203 are written back to activation memory 202 for processing on the same or another neural computation unit.

In various embodiments a microengine 204 is included in IPU 200. In such embodiments, all operations in the IPU are directed by the microengine. As set out below, central and/or distributed microengines may be provided in various embodiments. A global microengine may be referred to as a chip microengine, while a local microengine may be referred to as a core microengine or local controller. In various embodiments a microengine comprises one or more microengines, microcontrollers, state machines, CPUs, or other controllers.

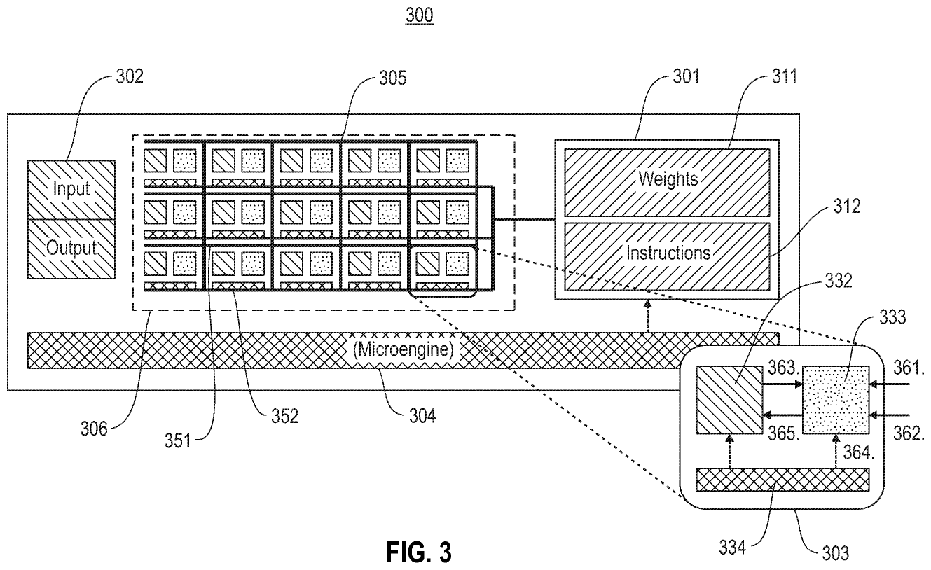

Referring to FIG. 3, a multi-core Inference Processing Unit (IPU) is illustrated according to embodiments of the present disclosure. IPU 300 includes a memory 301 for the neural network model and instructions. In some embodiments, memory 301 is divided into weight portion 311 and instruction portion 312. As described above, the neural network model may include the synapse weights for a neural network to be computed. IPU 300 includes an activation memory 302, which may be transient. Activation memory 302 may be divided into input and output regions, and stores neuron activations for processing.

IPU 300 includes an array 306 of neural cores 303. Each core 303 includes a computation unit 333, which is loaded with a neural network model from model memory 301 and is operative to perform vector computation. Each core also includes a local activation memory 332. Input activations are provided from local activation memory 332 in advance of each computation step. Outputs from computation unit 333 are written back to activation memory 332 for processing on the same or another computation unit.

IPU 300 includes one or more network-on-chip (NoC) 305. In some embodiments, a partial sum NoC 351 interconnects the cores 303 and transports partial sums among them. In some embodiments, a separate parameter distribution NoC 352 connects cores 303 to memory 301 for distributing weights and instructions to cores 303. It will be appreciated that various configurations of NoC 351 and 352 are suitable for use according to the present disclosure. For example, broadcast networks, row broadcast networks, tree networks, and switched networks may be used.

In various embodiments a global microengine 304 is included in IPU 300. In various embodiments, a local core controller 334 is included on each core 303. In such embodiments, the global microengine (chip microengine) and the local core controller (core microengine) collaboratively direct operations. In particular, at 361, compute instructions are loaded from instruction portion 312 of model memory 301 to the core controller 334 on each core 303 by global microengine 304. At 362, parameters (e.g., neural network/synaptic weights) are loaded from weight portion 311 of model memory 301 to the neural computation unit 333 on each core 303 by global microengine 304. At 363, neural network activation data are loaded from activation local activation memory 332 to neural computation unit 333 on each core 303 by local core controller 334. As noted above, the activations are provided to the neurons of the particular neural network defined by the model, and may originate from the same or another neural computation unit, or from outside the system. At 364, neural computation unit 333 performs the computation to generate output neuron activations as directed by local core controller 334. In particular, the computation comprises applying the input synaptic weights to the input activations. It will be appreciated that various methods are available for performing such computations, including in silico dendrites, as well as vector multiplication units. At 365, the results from computation are stored in local activation memory 332 as directed by local core controller 334. As described above, these stages may be pipelined, in order to provide efficient usage of the neural computation unit on each core. It will also be appreciated that inputs and outputs may be transferred from local activation memory 332 to global activation memory 302 according to the requirements of a given neural network.

Accordingly, the present disclosure provides for runtime control of operations in an Inference Processing Unit (IPU). In some embodiments, the microengine is centralized (single microengine). In some embodiments, the IPU computation is distributed (performed by an array of cores). In some embodiments, runtime control of operations is hierarchical—both a central microengine and distributed microengines participate.

The microengine or microengines direct the execution of all operations in the IPU. Each microengine instruction corresponds to several sub-operations (e.g., address generation, load, compute, store, etc.) Core microcode is run on the core microengines (e.g., 334). In the case of local computation, the core microcode includes instruction(s) to execute a full, single tensor operation. For example, a convolution between a weight tensor and a data tensor. In the case of distributed computation, the core microcode includes instruction(s) to execute a single tensor operation on the locally stored subset of the data tensor (and partial sums). Chip microcode is run on the chip microengine (e.g., 304). Microcode includes instructions to execute all of the tensor operations in a neural network.

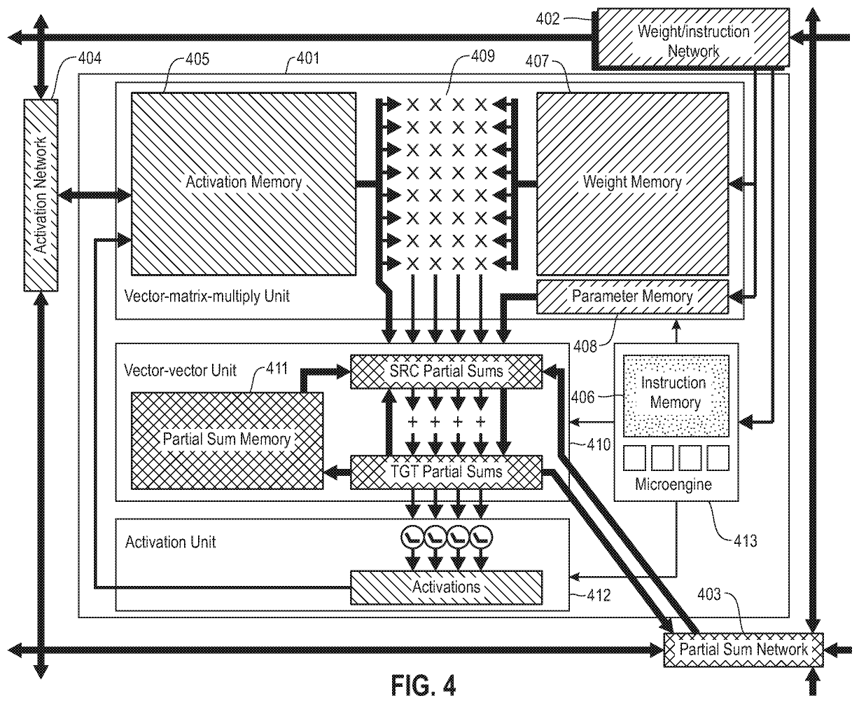

With reference now to FIG. 4, an exemplary neural core and associated networks are illustrated according to embodiments of the present disclosure. Core 401, which may be embodied as described with reference to FIG. 1 is interconnected with additional cores by networks 402 . . . 404. In this embodiments, network 402 is responsible for distributing weights and/or instructions, network 403 is responsible for distributing partial sums, and network 404 is responsible for distributing activations. However, it will be appreciated that the various embodiments of the present disclosure may combine these networks, or further separate them into multiple additional networks.

Input activations (X) are distributed core 401 from off-core via activation network 404 to activation memory 405. Layer instructions are distributed to core 401 from off-core via weight/instruction network 402 to instruction memory 406. Layer weights (W) and/or parameters are distributed to core 401 from off-core via weight/instruction network 402 to weight memory 407 and/or parameter memory 408.

The weight matrix (W) is read from weight memory 407 by Vector Matrix Multiply (WM) unit 409. The activation vector (V) is read from activation memory 405 by Vector Matrix Multiply (WM) unit 409. Vector Matrix Multiply (WM) unit 409 then computes vector-matrix multiplication Z=X^{T}W and provides the result to Vector-Vector unit 410. Vector-Vector unit 410 reads additional partial sums from partial sum memory 411, and receives additional partial sums from off-core via partial sum network 403. A vector-vector operation is computed by Vector-Vector unit 410 from these source partial sums. For example, the various partial sums may in turn be summed. The resulting target partial sums are written to partial sum memory 411, sent off-core via partial sum network 403, and/or fed back for further processing by Vector-Vector unit 410.

The partial sum results from Vector-Vector unit 410, after all computation for a given layer's inputs is complete, are provided to activation unit 412 for the computation of output activations. The activation vector (Y) is written to activation memory 405. Layer activations (including the results written to activation memory) are redistributed across cores from activation memory 405 via activation network 404. Upon receipt, they are written to local activation memory to each receiving core. Upon completion of processing for a given frame, the output activations are read from activation memory 405 and sent off-core via network 404.

Accordingly, in operation, a core control microengine (e.g., 413) orchestrates the data movement and computation of the core. The microengine issues a read activation memory address operation to load an input activation block into the vector-matrix multiply unit. The microengine issues a read weight memory address operation to load a weight block into the vector-matrix multiply unit. The microengine issues the vector-matrix multiply unit a compute operation, causing the vector-matrix multiply unit to compute a partial sum block.

The microengine issues one or more of a partial sum read/write memory address operation, vector compute operation, or partial sum communication operation in order to do one or more of the following: read partial sum data from partial sum sources; compute using partial sums arithmetic units; or write partial sum data to partial sum targets. Writing partial sum data to partial sum targets may include communicating external to the core via the partial sum network interface or sending partial sum data to the activation arithmetic unit.

The microengine issues an activation function compute operation, such that the activation function arithmetic unit computes an output activation block. The microengine issues a write activation memory address and the output activation block is written to the activation memory via the activation memory interface.

Accordingly, a variety of sources, targets, address types, computation types, and control components are defined for a given core.

Sources for vector-vector unit 410 include Vector Matrix Multiply (VMM) unit 409, constants from parameter memory 408, partial sum memory 411, partial sum results from prior cycles (TGT partial sums); and partial sum network 403.

Targets for vector-vector unit 410 include partial sum memory 411, partial sum results for subsequent cycles (SRC partial sums), activation unit 412, and partial sum network 403.

Accordingly, a given instruction may read or write from activation memory 405, read from weight memory 407, or read or write from partial sum memory 411. Compute operations performed by the core include vector matrix multiplication by VMM unit 409, vector (partial sum) operations by vector-vector unit 410, and activation functions by activation unit 412.

Control operations include updating program counters and loop and/or sequence counters.

Thus, memory operations are issued to read weights from addresses in weight memory, read parameters from addresses in parameter memory, read activations from addresses in activation memory, and read/write partial sums to addresses in partial sum memory. Computation operations are issued to perform vector-matrix multiplication, vector-vector operations, and activation functions. Communication operations are issued to select the vector-vector operands, route messages on the partial sum network, and select partial sum targets. Loops over layer outputs and loops over layer inputs are controlled by control operations specifying program counters, loop counters, and sequence counters in microengines.

Data distribution can be provided from a global memory array according to embodiments of the present disclosure. Global memory array includes a plurality of elements, each comprising a memory element and a buffer. Weights and instructions are provided from global array to array of cores via network. An exemplary configuration of cores is discussed above with regard to FIG. 3. Memory 303 in FIG. 3 may be implemented as described in connection with global memory array.

As set out above, a many core architecture for neural inference provides a significant advantage in computing power. However, if the neural network weights and parameters are not provided to computation cores on time, the cores cannot perform any useful computation. As a result, the performance of a neural chip may be limited by the capability of delivering neural network weights and parameters to computation cores on the chip. On-chip memory greatly improves the memory bandwidth compared to typical off-chip memory such as Dynamic Random-Access Memory (DRAM) or High Bandwidth Memory (HBM). Moreover, on-chip memory is more energy-efficient than off-chip memory, leading to a more power-efficient neural inference system. In various embodiments, the on-chip memory may comprise Static Random-Access Memory (SRAM) or other embedded memories. However, delivering neural network weights to cores at the rate commensurate with the processing speed remains a challenge.

Particular efficiencies may be realized with Convolutional Neural Networks (CNN). In CNNs, the same weight matrix (sometimes referred to as a convolutional filter) is repeatedly used. To minimize the amount of on-chip memory used, it is preferable to store a given weight matrix in one place with no duplication. In order to store a large neural network, some embodiments of the on-chip memory consist of a collection of many memory elements. It will also be appreciated that the many cores are the target of the memory weights. This result in a many-to-many communication problem (many memory elements to many cores). The broadcasting of weights can create network-on-chip (NoC) congestion, and may create a number of conflicts and pipeline stalls, leading to degradation of broadcasting bandwidth.

As outlined above, in various embodiments of a neural inference chip, a grid of neural inference cores is provided to accelerate neural network inference. In various embodiments, prescheduling of instructions is provided. Neural network evaluation involves a regular pattern of computation, and so instructions can be prescheduled without any stalls in order to achieve high performance. However, it is preferred that all the neural network weights are delivered to the cores just-in-time as prescheduled. If the weight delivery network is congested and weight delivery stalls, the prescheduling of neural network evaluation fails.

The present disclosure provides for a stall-less weight delivery network-on-chip to deliver weight parameters from a grid of memory elements to a grid of computation cores. The one dimensional scheme is first shown below, and then extended to a two-dimensional grid scheme. These approaches are further extended to support different weight distributions such as striping (where different rows of cores get different weights).

The approaches described herein work without conflict even if the time to deliver instruction to the memory element and deliver data from the memory element to computing cores varies. These approaches address instruction flow that can access any column at any order. The new schemes remove the constraint that all columns start at the same time.

In accordance with an aspect of the disclosure, the avoidance of (or reduction in) data dependent branching is capitalized on to provide a more efficient system. Data dependent branching refers to a situation where one instruction's read/write address intersects another instruction's write address, and there is a run-time execution path between the two instructions. The architecture of the systems disclosed herein does not use data dependent branching—when those systems involve standard deep networks with no dynamic updating of the instructions and/or operations (Op). The present disclosure is also applicable to systems which include writing Unified Memory to Singleton Condition Operation (via Inoc), followed by updating Unified memory using the neural network output and then repeating the above—which could include data dependent branching (since the data in unified memory controls which operation gets executed, which in turn, controls which unified memory bank gets updated).

Accordingly, the present disclosure provides numerous advantages, e.g., the compiler can schedule the timing of the various operations so that there are no collisions, race conditions etc. Similarly, the advantages presented to the spec validator (and its associated hardware verification use), the computation performed by each layer of a modelled deep neural network can be represented by strings of variables/symbols since the actual behavior of the network does not depend on the values assigned to those variables.

The present disclosure provides an approach that realizes these advantages for the purpose of symbolic verification that is independent of the actual values assigned to the variables. For example, the present disclosure demonstrates: i) how symbolic verification can complement numeric based verification; ii) how symbolic verification can speed up the development of assembly code for the ecosystem (e.g. NorthPole), by separating the data scientist's job of training a network, from the assembly developer's job of validating the correctness of his assembly code. Moreover, numerical validation is useful at runtime where individual data is fed-in and the numerical output is observed. In contrast, symbolic validation is beneficial for compile-time where it is independent of actual data due to the lack of any data-dependent branching in the architecture. The present disclosure balances the benefits of these validation techniques to provide an optimal solution. In some embodiments, prescheduleness, e.g. giving a unique symbolic result thereby making it possible to do the symbolic verification, can be employed. In some embodiments prescheduleness is not employed, e.g. if the machine has out-of-order execution, stalled, etc.

As noted above, the present disclosure can include symbolic and numerical calculations in the validator. Numerical calculation involves the exclusive use of integers and floating point numbers (fp16) for representing the input, and output of the actual operations that will be performed by the actual hardware. For example, given a weight matrix and an input activation, the respective values are represented using integers/fp16, and the operations involved in the matrix multiplication (addition, multiplication) also take as input and produce as output numerical values. Some examples of the advantages of numerical calculations include their speed (i.e. fast, thus execute multiple tests can be executed in the least amount of time); also, this approach most closely resembles what actual hardware does. Conversely, some examples of the disadvantages of numerical calculations include:
there is no one-to-one mapping between the output and input; instead multiple different inputs can give the same output;
Lacks certainty that output is correct because all the intermediate calculations were also correct (e.g., output can be correct by mere random chance);
Since fp16 ops introduce an error/uncertainty region, no certainty that small errors in the output are not due to some implementation bug instead of simply roundoff/machine epsilon issues;
Depending on compiler placement of the core code, partials sums might be added in a different order introducing variability in the output (since floating point operations are not commutative).

On the other hand, symbolic calculations use a distinct variable to represent each distinct weight and/or activation, and another variable to represent operations that can be performed on weight and/or activations, or the output of other operations. The output of each neuron in a neural network is therefore represented by a string produced by an architecture specific grammar. Some examples of the advantages of symbolic calculations are they do not involve fp16 errors, are exact, do not include numbers (thus no rounding errors), but rather consist of variables only. Also, one-to-one mapping between output and input with symbolic calculations. Thus, given two identical symbolic output strings, one can know that both strings represent the same architecture (matrix dimensions, fan-in, fan-out, etc.) Further, symbolic calculations provide one representation, or unique identification string, for the operations involved across multiple layers. Conversely, some examples of the disadvantages of symbolic calculations include:
Long strings slow the simulator/validator and increase memory use, thus applicable for processing smaller networks than a purely numerical calculation;
Canonical representation of the multiplication results are required for comparison (e.g., variability in output result of (x+y)*(w+z) as either xw+yz+yw+xz or as wx+zy+wy+zx);
Possible representations of variables can grow exponentially;
Difficult for user to visualize the output of large networks (e.g., Resnets);
Cannot be used to detect certain bugs, such as overflows, since most operations are symbolic.

Accordingly, symbolic and numerical calculations both have their advantages and disadvantages, with no single mode being optimal in all cases, thus, and in accordance with the present disclosure, a mix of both numeric and symbolic modes is optimum. Numerical mode is selected for runtime validation where individual data is fed in and the numerical output is observed. In contrast, symbolic validation is selected for compile-time where it is independent of actual data. The present disclosure provides a system that can produce symbolic and numeric representations of the neural network outputs, such that these outputs can be used to validate correctness of the implementation of the neural network. By incorporating symbolic computation, better coverage of the validator source code is obtained, thereby decreasing the probability of not catching implementation or spec bugs that could be missed using a purely numerical approach—which can be particularly advantageous when implemented in architectures that do not have data dependent branching. Employing a framework using a mix of both numerical and symbolic calculations increases validator coverage and reliability of calculations. When implemented, the user provides a ground truth grammar file, which can contain only a list of valid strings, or in some embodiments, can encode the ground truth strings using a more complex representation (e.g., context free grammars). In the exemplary embodiments depicted herein, the ground truth strings are represented using context free grammars.

In an exemplary embodiment, ground truth generation in numerical mode can be provided by a variety of machine learning frameworks, e.g., PyTorch. In symbolic mode, ground truth can be provided manually by the user through the use of Context Free Grammars to represent the ground truth compactly, or via simple text files (customized by user) containing lists of acceptable string symbols or directed acyclic graphs (DAG) representing the ground truth. This can be useful for simple architectures (e.g., single layer convolutions) where the representational complexity is not too high, some representative examples of generating such ground truths are described below. However, much more complex symbolic representations need to be generated for complex deep networks like Resnets. This can be semi-automated by manually specifying the ground truth of individual layers, but automating the composition/aggregation of multiple layers' symbolic representation through, e.g., a compiler module.

For purpose of illustration and not limitation, the ONNX graph can be considered a symbolic representation of a deep network that is independent of any NorthPole architectural details, where the Data Scientist that coded the layer specifies each layer's initial symbolic representation. The ground truth symbolic representation that is created by the toolchain is effectively an augmentation of this ONNX graph. The compiler's primary function is to augment it with NorthPole architectural details to generate a ground truth, and the validator's primary function is to generate the same symbolic graph/string from an elf file. For instance, the input activations of an ONNX graph can be augmented with indices in the chip memories (Weight Buffer, Activation Memory etc.) that the compiler believes should be used at every cycle. The validator should generate the same symbolic representation from the elf file, if the two representation do not match, it signifies a bug somewhere in the pipeline.

An exemplary context free grammar can be defined as G=(V,U,R,S) where:
V: a finite set of non-terminal symbols
U: a finite set of terminal symbols
R: a set of mappings from V to (V∪Σ)*
S: the start symbol which belongs to V
   Example 1: Two character words concatenated with their reverse:
V={S}
U={a,b}
R={S→aSa, S→bSb, ε}
   The language of this grammar includes strings such as aabbaa, baab, etc.
   Example 2: Algebraic expressions of 3 variables x,y,z:
V={S}
U={x, y, z}
R={S→x, S→y, S→z, S→S+S, S→S−S, S→S*S, S→S/S, S→(S)}
   The language of this grammar includes for example the string (x+y)*x−z*y/(x+x).

In accordance with an aspect of the disclosure, the spec validator (which is a network of queues that can introduce pipeline delays) is endowed with output symbolic representations of the result. Given such a string representation as output, the verification stage then checks that the string belongs to the language corresponding to the ground truth grammar. This implies that, as part of the verification phase, the user needs to provide a ground truth file/grammar. Here, this symbolic representation also makes it trivial to quantify NorthPole functioning, in terms of its performance (e.g., fps, watts, cycles per frame etc.) with respect to the number of operations (e.g., multiplications, additions) required to do inference on a particular deep neural network architecture, from a minimum encoding length perspective. Instead, performance assessment is simply a matter of calculating the number of operations (additions, multiplications etc.) in the canonical string symbolic representation of the result, and comparing this value with the number of cycles necessary in the assembly code, or the power usage observed on the physical chip. Accordingly, this approach can be useful as a developer tool for, e.g., assembly code optimization. It will be appreciated that a variety of descriptions of an artificial neural network are suitable for use as described herein, including assembly code, procedural human readable code, or other neural network descriptor languages known in the art.

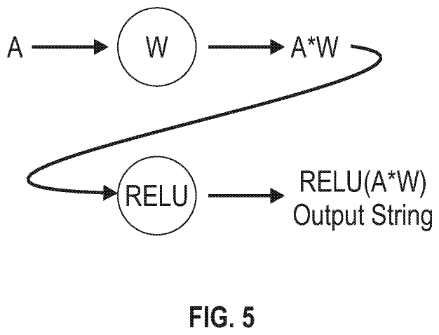

FIG. 5 depicts an exemplary embodiment of a 3×3 convolution with RELU Here, with a 3×3 weight matrix, there are 9 weights, w_{1,1}, w_{1,2}, . . . , w_{3,3} represented by a 3×3 matrix W. Also, an N×3 activation matrix A is left multiplied to this weight matrix giving A*W, with the (i,j) element of A being represented by symbol a_{i,j}.

In the example shown, a RELU is applied to each of the N*3 elements of A*W, represented by RELU(A*W), and the matrix includes 8 bit signed activations. In practice the bit length & signedness can be represented by extra subscripts in the activation terminal symbols, with the validator producing a string. This string is compared to determine if it belongs to the language generated by the ground truth context free grammar. If this is not the case, an error is flagged. For example, if a different activation function is used instead of a RELU, this is considered a mistake. Without a symbolic representation of the output, one could still observe the same numeric output for certain numeric inputs—even though a different activation function is used.

The example illustrated in FIG. 5 includes the following variables:
V={S, T}
U={W, A}
R={T→RELU(S), S→A*W}
   For example, if an activation a_{M, 1} is used in the output string, where M>N, it implies that an improper activation memory region has been accessed, and this should be flagged as an error, since the resulting string does not belong to the language generated by the above grammar. Similarly, if a weight value other than w_{1,1}, . . . , w_{3,3} is used, it signifies an error (e.g., the operation could be accessing the wrong weight buffer index). If all weight buffer matrices had the same numeric value, this bug would not be detectable as the same numeric output would be produced regardless of matrix accessed.

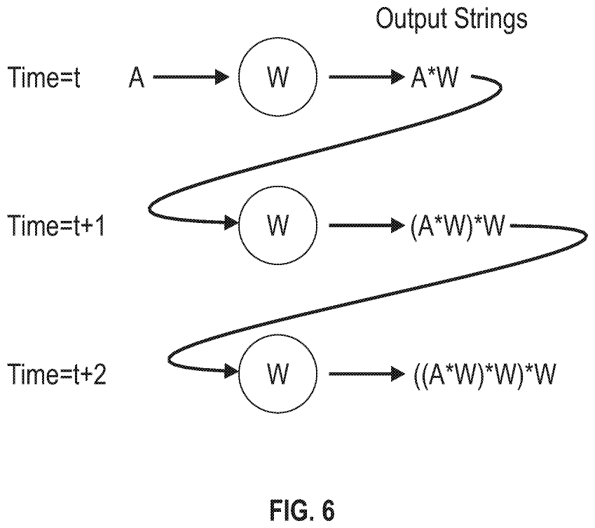

FIG. 6 depicts an exemplary embodiment including recurrent nets, which include the element of time. Here, a 1×1 weight matrix W=[w_{1,1}] is multiplied by a single activation value A=[a{1,1}] and the result is then sent back as input recurrently. Accordingly, valid language strings of all possible outputs include:
A*W, (A*W)*W, ((A*W)*W)*W, etc.
   If one wanted to know that after 10*N cycles, the matrix has recursed N times, where N can be arbitrary, the ground truth grammar would be as follows:
V={S}
U={W,A}
R={S→A*W, S→(S)*W}
   By analyzing the symbolic string, it is trivial to add an appropriate correctness assertion. In this scenario an error could occur, e.g., if the mnoc modifies the wrong thread instruction buffer, and as a result after some time multiplication by a weight other than w_{1,1} is performed—for instance, weight w_{2,2}, which is located in another weight buffer memory location. By employing such a symbolic representation, it is trivial to detect this bug and to detect the cycle where the error was introduced. This allows for the location of the mnoc update that caused the problem to be readily identified, since the symbolic string provides a human interpretable trace of the program execution.

In another exemplary embodiment including the NorthPole architecture, a high-level algorithm, or scheme, can be described in a “master loops” form. Here, a specific NorthPole code generator implements a specific NorthPole scheme where, conceptually, the code generator is responsible for producing assembly code to be transformed into NorthPole executable machine code. Often training/architecture search (e.g., number of layers, connectivities, weight values, etc.) is a time-intensive endeavor taking in some situations weeks to complete. However, the code generator assembly code is available much earlier and is waiting to be tested. Thus, a purely numerical methodology for evaluating correctness of the assembly code introduces a blocker in system development since assembly code correctness cannot be numerically validated until training is complete (at least where random & non-final architectures/weights are not employed). By implementing a symbolic validator as disclosed herein, the validation process can commence even though training is not complete for scenarios in which a NP-Pytorch/NP-compiler of a symbolic ground truth generator can be employed to generate the ground truth string. In some embodiments, the ground truth string is independent of the weights learned during training.

A benefit of this exemplary embodiment is that the job of the assembly code writer in the NorthPole ecosystem is less dependent on the data scientist having completed the training. For instance, the assembly code writer no longer needs ground truth provided by the data scientist to begin testing the correctness/timing of the assembly code. This problem can occur when the non-commutativity of fp16 introduces significant delays until the assembly code writers can verify correctness of their code by comparing it with the numerical output of PyTorch. In such scenarios, the data scientists has to spend a significant amount of time to ensure the fp16 operations were done in a correct order to provide identical numerical results as the NorthPole simulator (because floating point operations are non-commutative, and these errors tend to expand exponentially as the size of the network increases).

Accordingly, a symbolic validator as described herein remains independent of these problems and provides the assembly code writer the ability to make significant progress in debugging the code in parallel or simultaneously with the data-scientist's efforts of training the system. Additionally, this approach provides a development feature that is advantageous from a human computer interaction perspective.

In another exemplary embodiment, the system and techniques disclosed herein can include floating point operations. Since floating point operations are not commutative, systems employing these (e.g. fp16 operations in NorthPole architecture) can generate numerical output that differ depending on how the compiler places the instructions on the various cores. For example, if the compiler uses a random search to do the code placement in the different NorthPole cores, the order of the partial sum additions can differ with each placement. That is, the fp16 value of x+y+z is not necessarily equal to y+z+x. However, and in accordance with the present disclosure, by using a DAG representation (as described in further detail below) the symbolic representation of x+y+z and y+z+x will match. Therefore, the symbolic representations simplify the task of verifying correctness with ground truth for very large Deep Networks (e.g., resnets and/or recurrent networks) where the errors can expand significantly with time—whereas a purely numerical validator we could not do the test described above.

In another exemplary embodiment, the system and techniques disclosed herein can combine vertical assertions with symbolic representation. As described above, it can be desirable and advantageous to check that the user is not programming NorthPole with a behavior that results in data-dependent branching. This can happen if at runtime one dynamically changes the unified memory boundaries between model memory and activation memory, as then an activation value could be written in an instruction buffer. However, one could also dynamically change the unified memory boundaries to temporarily increase activation memory and then rewrite the original model memory values that were overwritten. Such an approach would result in an acceptable program free of data dependent branching.

The present disclosure can be employed to verify that the accessing of unified memory data does not result in data-dependent branching by using a symbolic representation that is propagated across time, and combined with indices and/or addresses in the unified memory denoting the address and cycle number when the unified memory data was accessed. Thus, and in accordance with an aspect of this disclosure, vertical assertions can be combined with a symbolic representation to achieve something that would not be possible using a purely numerical validator.

In another aspect of the present disclosure, the system and techniques disclosed herein can be implemented in a directed graph of network of queues. As described above, one symbolic representation can be obtained for one network. However, even for a single network, different inputs can lead to different outputs. Furthermore, instead of the value of a variable, the present disclosure can access the name and/or location of the variable. Also, in light of the close relationship between the network of queues directed graph representation of a network implementation and the grammars which generate the language of correct outputs, the queues can be used to represent the hardware pipeline delays. Therefore, a grammar file can generate a network of queues graph representation of some architecture, but without the queues which assign the corresponding pipeline delays.

Accordingly, the present disclosure provides a unique approach to the applicability of joint symbolic and numeric methods for the verification of neuromorphic architectures, with no data dependent branching.

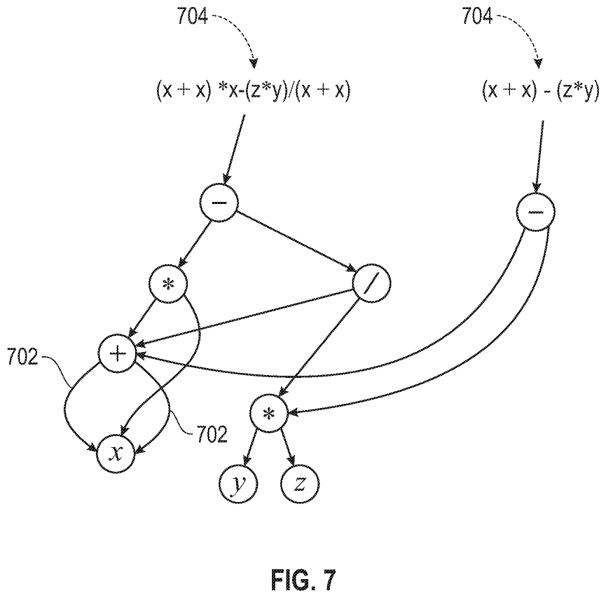

FIG. 7, depicts an exemplary embodiment of the present disclosure employing directed acyclic graph (DAG) to represent symbolic values. Here, the symbolic values can be represented by DAG, with any common subexpressions being shared by simply duplicating pointers 702. This DAG representation of the symbolic values is significantly smaller than the string representation 704, especially when the size of the expression expands with many common subexpressions. As illustrated, the use of Isomorphic DAG reduction can be implemented to make sure all isomorphic DAG in the system are reduced to a single object. If that is the case, the comparison of two symbolic values can be done by a pointer comparison. No DAG traversal is necessary to test the equality between two symbolic values. Accordingly, the present disclosure provides methods for debugging and co-designing complex distributed and parallel chip architectures

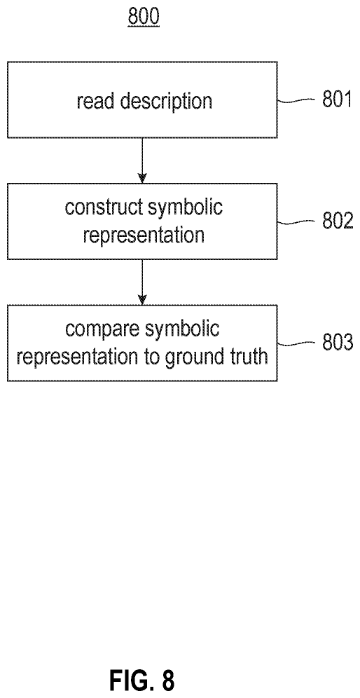

Referring to FIG. 8, a method of validating a neural network system is illustrated. At 801, a description of an artificial neural network containing no data-dependent branching is read. At 802, based on the description of the artificial neural network, a symbolic representation is constructed of an output of the artificial neural network, the symbolic representation comprising at least one variable. At 803, the symbolic representation is compared to a ground truth symbolic representation, thereby validating the neural network system.

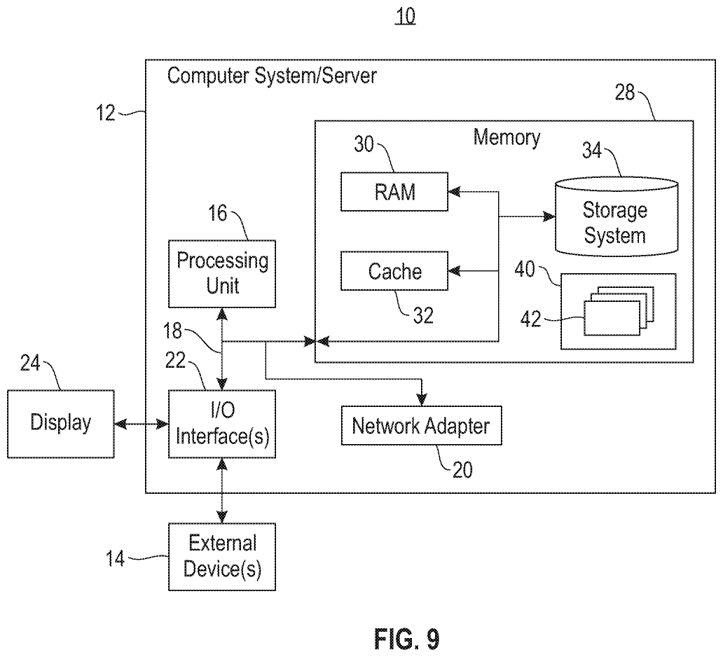

Referring now to FIG. 9, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

In various embodiments, one or more inference processing unit (not pictured) is coupled to bus 18. In such embodiments, an IPU may receive data from or write data to memory 28 via bus 18. Likewise, an IPU may interact with other components via bus 18 as described herein.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of validating a neural network system, the method comprising:
reading a description of an artificial neural network containing no data-dependent branching;
based on the description of the artificial neural network, constructing a symbolic representation of an output of the artificial neural network, the symbolic representation comprising at least one variable;
comparing the symbolic representation to a ground truth symbolic representation, thereby validating the neural network system.

2. The method of claim 1, wherein the artificial neural network is a deep neural network.

3. The method of claim 1, wherein the symbolic representation has configurable granularity.

4. The method of claim 3, wherein the symbolic representation comprises at least one numeric value.

5. The method of claim 1, further comprising:
determining, from a number of operations in the symbolic representation, a number of cycles required for computation of the artificial neural network.

6. The method of claim 1, further comprising:
evaluating the symbolic representation using input data to determine an output of the artificial neural network.

7. The method of claim 1, further comprising:
comparing the symbolic representation to a ground truth string, thereby validating an output of the neural network system.

8. The method of claim 1, wherein the symbolic representation is a string.

9. The method of claim 1, wherein the symbolic representation is a directed acyclic graph.

10. A computer program product for validating a neural network system, the computer program product comprising a computer readable storage medium having program instructions embodied therewith, the program instructions executable by a processor to cause the processor to perform a method comprising:
reading a description of an artificial neural network containing no data-dependent branching;
based on the description of the artificial neural network, constructing a symbolic representation of an output of the artificial neural network, the symbolic representation comprising at least one variable;
comparing the symbolic representation to a ground truth symbolic representation, thereby validating the neural network system.

11. The computer program product of claim 10, wherein the artificial neural network is a deep neural network.

12. The computer program product of claim 10, wherein the symbolic representation has configurable granularity.

13. The computer program product of claim 12, wherein the symbolic representation comprises at least one numeric value.

14. The computer program product of claim 10, the method further comprising:
determining, from a number of operations in the symbolic representation, a number of cycles required for computation of the artificial neural network.

15. The computer program product of claim 10, the method further comprising:
evaluating the symbolic representation using input data to determine an output of the artificial neural network.

16. The computer program product of claim 10, the method further comprising:
comparing the symbolic representation to a ground truth string, thereby validating an output of the neural network system.

17. The computer program product of claim 10, wherein the symbolic representation is a string.

18. The computer program product of claim 10, wherein the symbolic representation is a directed acyclic graph.

19. A system comprising:
a computing node comprising a computer readable storage medium having program instructions embodied therewith, the program instructions executable by a processor of the computing node to cause the processor to perform a method comprising:
reading a description of an artificial neural network containing no data-dependent branching;
based on the description of the artificial neural network, constructing a symbolic representation of an output of the artificial neural network, the symbolic representation comprising at least one variable;
comparing the symbolic representation to a predetermined symbolic representation, thereby validating the neural network system.

20. The system of claim 19, the method further comprising:
determining, from a number of operations in the symbolic representation, a number of cycles required for computation of the artificial neural network.
